(19) United States
(12) Patent Application Publication
(10) Pub. No.: US 2016/0314592 A1
(43) Pub. Date: Oct. 27, 2016

(54) METHOD AND APPARATUS FOR REGISTRATION OF INTERIOR AND EXTERIOR THREE DIMENSIONAL SCANS BASED ON A SEMANTIC FEATURE OF A STRUCTURE

(71) Applicant: Nokia Technologies Oy, Espoo (FI)

(72) Inventors: Xin Chen, Evanston, IL (US); Ruigang Yang, Lexington, KY (US)

(21) Appl. No.: 14/694,072

(22) Filed: Apr. 23, 2015

(51) Int. Cl. G06T 7/00

(52) U.S. Cl. CPC G06T 7/0032; G06T 2200/04; G06T 2200/08; G06T 2210/04

(57) ABSTRACT

A method, apparatus and computer program product are provided for registration of interior and exterior three dimensional scans based on a semantic feature of a structure. A method is provided including receiving at least one exterior scan and at least one interior scan of a structure and registering the at least one exterior scan and the at least one interior scan based on a semantic feature of the structure. The sematic feature of the structure is present in the at least one exterior scan and the at least one interior scan.

### TECHNOLOGICAL FIELD

An example embodiment of the present invention relates to three dimensional scan registration and, more particularly, to registration of interior and exterior three dimensional scans based on a semantic feature of a structure.

### BACKGROUND

There are currently several systems, such as laser scanners, for obtaining a three dimensional scan of the exterior of a structure, such as a building. Similar technologies may be used to capture a three dimensional scan of the interior of a structure. The exterior three dimensional scan may be anchored by utilizing location data, or a beacon, for the instrument performing the scan, such as global positioning systems (GPS). However, interior scans do not have such a location anchor and may rely on an inertial measuring unit or image based feature tracking for localization. These methods of interior scan localization may be fragile in practice or have a cumulative error resulting in tracking failure or inaccuracy of interior scans.

### BRIEF SUMMARY

A method and apparatus are provided in accordance with an example embodiment for registration of interior and exterior three dimensional scans based on a semantic feature of a structure. In an example embodiment, a method is provided that includes receiving at least one exterior scan and at least one interior scan of a structure and registering the at least one exterior scan and the at least one interior scan based on a semantic feature of the structure. The sematic feature of the structure is present in the at least one exterior scan and the at least one interior scan.

In an example embodiment, the method also includes determining the semantic feature of the structure in the at least one exterior scan and the at least one interior scan. In some example embodiments, the method also includes associating a transform to the at least one interior scan and the registering the at least one exterior scan to the at least one interior scan comprises applying the transform to the at least one interior scan.

In some example embodiments of the method, the registering the at least one exterior scan and the at least one interior scan comprises applying a maximization function. In an example embodiment, the method also includes applying a non-linear regression to the maximization function. In some example embodiments, the method also includes refining the transform associated with the respective interior scans of the at least one interior scan based on the registration of the at least one exterior scan and the at least one interior scan. In an example embodiment, the method also includes outputting a composite structure model.

In another example embodiment, an apparatus is provided including at least one processor and at least one memory including computer program code, with the at least one memory and computer program code configured to, with the processor, cause the apparatus to at least receive at least one exterior scan and at least one interior scan of a structure and register the at least one exterior scan and the at least one interior scan based on a semantic feature of the structure. The sematic feature of the structure is present in the at least one exterior scan and the at least one interior scan.

In an example embodiment of the apparatus, the at least one memory and the computer program code are further configured to determine the semantic feature of the structure in the at least one exterior scan and the at least one interior scan. In some example embodiments of the apparatus, the at least one memory and the computer program code are further configured to associate a transform to the at least one interior scan and the registering the at least one exterior scan to the at least one interior scan comprises applying the transform to the at least one interior scan.

In some example embodiments of the apparatus, the registering the at least one exterior scan and the at least one interior scan comprises applying a maximization function. In an example embodiment of the apparatus, the at least one memory and the computer program code are further configured to apply a non-linear regression to the maximization function. In an example embodiment of the apparatus, the at least one memory and the computer program code are further configured to refine the transform associated with the respective interior scans of the at least one interior scan based on the registration of the at least one exterior scan and the at least one interior scan. In some example embodiments of the apparatus, the at least one memory and the computer program code are further configured to output a composite structure model.

In a further example embodiment, a computer program product is provided including at least one non-transitory computer-readable storage medium having computer-executable program code portions stored therein, with the computer-executable program code portions comprising program code instructions configured to receive at least one exterior scan and at least one interior scan of a structure and register the at least one exterior scan and the at least one interior scan based on a semantic feature of the structure. The sematic feature of the structure is present in the at least one exterior scan and the at least one interior scan.

In an example embodiment of the computer program product, the computer-executable program code portions further comprise program code instructions configured to determine a semantic feature of the structure in the at least one exterior scan and the at least one interior scan. In some example embodiments of the computer program product, the computer-executable program code portions further comprise program code instructions configured to associate a transform to the at least one interior scan and the registering the at least one exterior scan to the at least one interior scan comprises applying the transform to the at least one interior scan.

In an example embodiment of the computer program product, the registering the at least one exterior scan and the at least one interior scan comprises applying a maximization function. In some example embodiments of the computer program product, the computer-executable program code portions further comprise program code instructions configured to apply a non-linear regression to the maximization function. In an example embodiment of the computer program product, the computer-executable program code portions further comprise program code instructions configured to refine the transform associated with the respective interior scans of the at least one interior scan based on the registration of the at least one exterior scan and the at least one interior scan. In some example embodiments of the computer program product, the computer-executable program code portions further comprise program code instructions configured to output a composite structure model.

In yet a further example embodiment an apparatus is provided including means for receiving at least one exterior scan and at least one interior scan of a structure and means for registering the at least one exterior scan and the at least one interior scan based on a semantic feature of the structure, wherein the sematic feature of the structure is present in the at least one exterior scan and the at least one interior scan.

In an example embodiment, the apparatus also includes means for determining a semantic feature of the structure in the at least one exterior scan and the at least one interior scan. In some example embodiments, the apparatus also includes means for associating a transform to the at least one interior scan and the registering the at least one exterior scan to the at least one interior scan comprises applying the transform to the at least one interior scan.

In some example embodiments of the apparatus, the means for registering the at least one exterior scan and the at least one interior scan comprise means for applying a maximization function. In an example embodiment, the apparatus also includes means for applying a non-linear regression to the maximization function. In an example embodiment, the apparatus also includes means for refining the transform associated with the respective interior scans of the at least one interior scan based on the registration of the at least one exterior scan and the at least one interior scan. In an example embodiment, the apparatus also includes means for outputting a composite structure model.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a communications diagram in accordance with an example embodiment of the present invention;

FIG. 2 is a block diagram of an apparatus that may be specifically configured for registration of interior and exterior three dimensional scans based on a semantic feature of a structure in accordance with an example embodiment of the present invention;

FIGS. 3A-3D illustrate an example of interior and exterior scan registration in accordance with an example embodiment of the present invention in which FIG. 3A illustrates an interior scan of a structure including a semantic feature, e.g., a doorway, FIG. 3B illustrates an exterior scan of the structure with the semantic feature; FIG. 3C illustrates a registration of the interior and exterior scans based on the common semantic feature of each scan, and FIG. 3D illustrates a point cloud of the interior and exterior scans after registration based on the semantic feature; and

FIG. 4 illustrates an example process for registration of interior and exterior three dimensional scans based on a semantic feature of a structure in accordance with an embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

### Overview

Structures may have features that are discernable from both the exterior and interior. These semantic features may be used as calibration and refinement landmarks to register the interior scans to the external scans. Further, the registration of the interior scans to the external scan may provide one or more anchor points to refine the interior scan and/or associate one or more interior scans with one another.

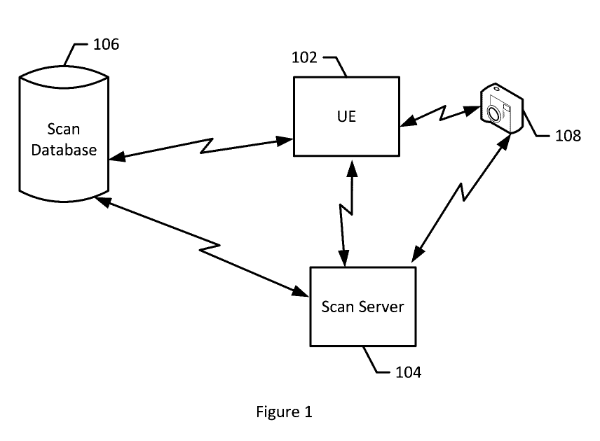

A method, apparatus and computer program product are provided in accordance with an example embodiment for image registration in the gradient domain. FIG. 1 illustrates a communication diagram including, an scan server 104 in data communication with a user equipment (UE) 102, scan database 106, and a scan capture device 108. The communication between devices may be a wired, wireless, or any combination of wired and wireless communication networks, such as cellular, WiFi, internet, local area networks, or the like.

The UE 102 may be a mobile computing device such as a laptop computer, tablet computer, mobile phone, smart phone, navigation unit, personal data assistant, watch, camera, or the like. Additionally or alternatively, the UE 102 may be a fixed computing device, such as a personal computer, computer workstation, kiosk, office terminal computer or system, or the like. The scan server 104 may be one or more fixed or mobile computing devices. The UE 102 and/or the scan server 104 may be in data communication with or otherwise associated with a scan capture device 108, e.g. three dimensional scanner.

The scan capture device 108 may be a portion of the UE 102 or otherwise associated with the UE or scan server 104. The scan capture device 108 may be a three dimensional scanner based on time of flight, triangulation, conoscopic holography, structured light, modulated light, or the like capable of capturing a three dimensional scan of an exterior or interior of a structure. Some scan capturing devices may include a laser range finder, LiDAR, radar, flash LiDAR, or the like. The scans may be a point cloud, or a data set in a three dimensional coordinate system representing the measured points of the structure.

The scan may be associated with location information, e.g. a two dimensional or three dimensional location, such as GPS, radio frequency identification (RFID), or the like. In some embodiments location data may be a calculated location based on an inertial measuring unit, image based feature tracking, RFID proximity, or the like.

The UE 102 or image server 104 may receive one or more external scans of the structure and one or more interior scans of the structure from the scan capture device 108 and/or from the scan database 106. The scans may include a one or more structures, features of the one or more structures, or the like. The interior scans may be registered based on the associated location data, which may include inaccuracy and drift.

The UE 102 or scan server 104 may determine one or more semantic features, such as windows, doors or the like which may be determinable in both the exterior and interior scans. The semantic features may be detected by either heuristic methods or supervised learning techniques, such as support vector machine (SVM), deep convolutional neural networks, or the like.

In an instance in which a heuristic method is utilized, the UE 102 or scan server 104 may detect plane primitives in the point clouds of the external and interior scans. The UE 102 or scan server 104 may assume a gravity vector and detect vertical planes. For each of the detected vertical planes, the UE 102 or scan server 104 may divide the vertical plane into a plurality of equal length bins and count the number of points in each bin. The same counting strategy may also be applied in the horizontal direction.

Semantic features, such as windows, doors, or the like, may be recessed from both exterior and interior walls. Therefore, a low point counter in both horizontal and vertical direction may indicate an opening. The UE 102 or scan server 104 may group neighboring bins which indicate an opening into a semantic feature, such as a window or door. Although the example of an opening due to a recess, such as a window or door is provided as an example, one of ordinary skill in the art would immediately appreciate that semantic features that protrude on both the exterior and interior walls, such as revolving doors, or semantic features that correspond to a protrusion on one side of the wall and a recess on the other side such as climate control door sets, may be similarly determined.

In an instance in which the structure is multi story, a horizontal scan may also be performed for the exterior scans. The intersection of low-counting vertical and horizontal bins may indicate a semantic feature, such as a window.

In some example embodiments, interior windows may be obfuscated by furniture, curtains, or the like. Supervised machine learning, such as those discussed above may be utilized to determine partially obfuscated semantic features, thereby increasing the robustness of the scan registration process.

The UE 102 or scan server 104 may perform a rough registration of the interior scans to the external scan, based on the location data associated with external scans, such as GPS and the location data associated with the interior scans, such as IMU and image based feature tracking. Each of the detected semantic features may be treated a single three dimensional point for the rough registration.

The UE 102 or scan server 104 may apply an iterative closest point (ICP) algorithm to find a rigid transformation between the exterior scans and interior scans. For each corresponding external and interior semantic feature, e.g. window pair Wₑ and W_{i,} the UE or scan server 104 may maximize the overlap between the semantic features and minimize the orientation difference of the plane to which the respective semantic feature corresponds, denoted Nₑ and N_{i.}

The UE 102 or scan server 104 may associate each of the interior scans with a rigid transformation T_{k.} The UE 102 or scan server 104 may apply the maximization function as follows.

max_{T}_{^{k}} ΣₖΣ_{j∈S}_{ₖ}∥f(Tₖwᵢ^{j}−wₑ^{j})∥+∥T^{k}Nᵢ^{j}·Nₑ^{j}∥ (1)

where f(.) is a function of the overlap between the exterior semantic feature Wₑ and the interior semantic feature Wᵢ.

The maximization function may be optimized by applying a non-linear regression, such as the LaGrange multiplier. The UE 102 or scan server 104 may apply the non-linear regression to maximize the overlap and minimize the orientation differences of the semantic features. In an example embodiment, UE 102 or scan server 104 may determine an error associated with the registration of the exterior scan and the interior scan. The transform applied to the interior scan may be incremented based on the non-linear regression and the re-performance of the registration, e.g. the maximization function of Equation 1 applied based on the incremented transform. The UE 102 or scan server 104 may determine an error associated with the second registration. The UE 102 or scan server 104 may repeat the transform incrementing and registration process, until the UE or scan server determines that the error satisfies a predetermined error threshold, such as zero or 10 mm, or the change in mean registration error satisfies a predetermined change threshold, such as zero or less than 0.1%.

Once the interior scans have been registered to the exterior scan, e.g. the semantic feature of the interior scan (Sₖ) has been registered with the corresponding semantic feature of the external scan, the UE 102 or scan server 104 may refine other points of the interior scan (Sₘ). Scan points Sₖ may be anchor points which do not change position during the interior refinement. The UE 102 and the scan sever 104 may apply transforms to the Sₘ points. The transforms may minimize the distance between the cloud points Sₘ and Sₖ of the interior scans. In an example embodiment, the UE 102 or scan server 104 may iteratively apply the maximization function to cloud points Sₘ and Sₖ, similar to the exterior scan and interior scan as discussed above.

The UE 102 or scan server 104 may generate a composite structure model based on the registered exterior and interior scans. The model can be defined with standard 3D model format, such as the WaveFront Obj format or the PLY format. The UE 102 or scan server 104 may store the composite structure model in a memory such as the scan database 106, or output the composite structure model to a display of the UE.

### EXAMPLE APPARATUS

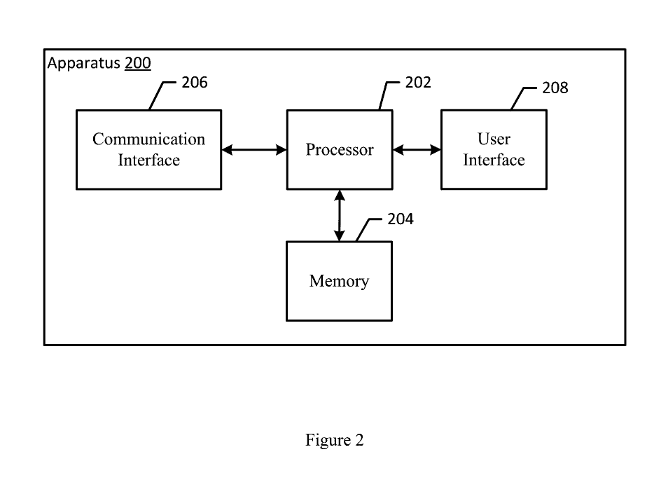

A UE 102 or scan server 104 may include or otherwise be associated with an apparatus 200 as shown in FIG. 2. The apparatus, such as that shown in FIG. 2, is specifically configured in accordance with an example embodiment of the present invention for registration of interior and exterior three dimensional scans based on a semantic feature of a structure. The apparatus may include or otherwise be in communication with a processor 202, a memory device 204, a communication interface 206, and a user interface 208. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 200 may be embodied by a UE 102 or a scan server 104. However, in some embodiments, the apparatus may be embodied as a chip or chip set. In other words, the apparatus may comprise one or more physical packages (for example, chips) including materials, components and/or wires on a structural assembly (for example, a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 202 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 202 may be configured to execute instructions stored in the memory device 204 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 200 of an example embodiment may also include a communication interface 206 that may be any means such as a device or circuitry embodied in either hardware or a combination of hardware and software that is configured to receive and/or transmit data from/to a communications device in communication with the apparatus, such as to facilitate communications with one or more user equipment 104, utility device, or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

The apparatus 200 may also include a user interface 208 that may, in turn, be in communication with the processor 202 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processor may comprise user interface circuitry configured to control at least some functions of one or more user interface elements such as a display and, in some embodiments, a plurality of speakers, a ringer, one or more microphones and/or the like. The processor and/or user interface circuitry comprising the processor may be configured to control one or more functions of one or more user interface elements through computer program instructions (for example, software and/or firmware) stored on a memory accessible to the processor (for example, memory device 204, and/or the like).

### Example of Interior and Exterior Scan Registration

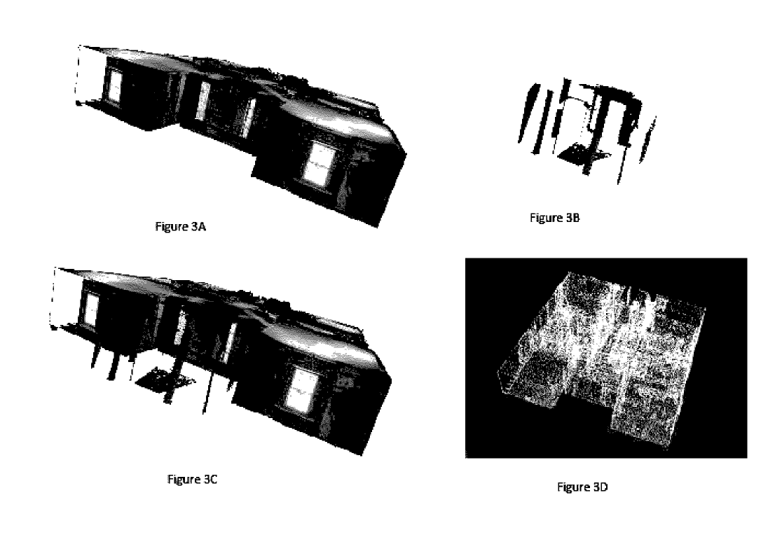

FIGS. 3A-D illustrate an example of an interior and exterior scan registration in accordance with an example embodiment of the present invention. FIG. 3A illustrates an interior scan of a structure including a semantic feature, e.g. a doorway. FIG. 3B illustrates an exterior scan of the structure with the semantic feature. FIG. 3C illustrates a registration of the interior and exterior scans based on the common semantic feature of each scan. FIG. 3D illustrates a point cloud of the interior and exterior scans after registration based on the semantic feature.

### Example Process for Registration of Interior and Exterior Three Dimensional Scans Based on a Semantic Feature of a Structure

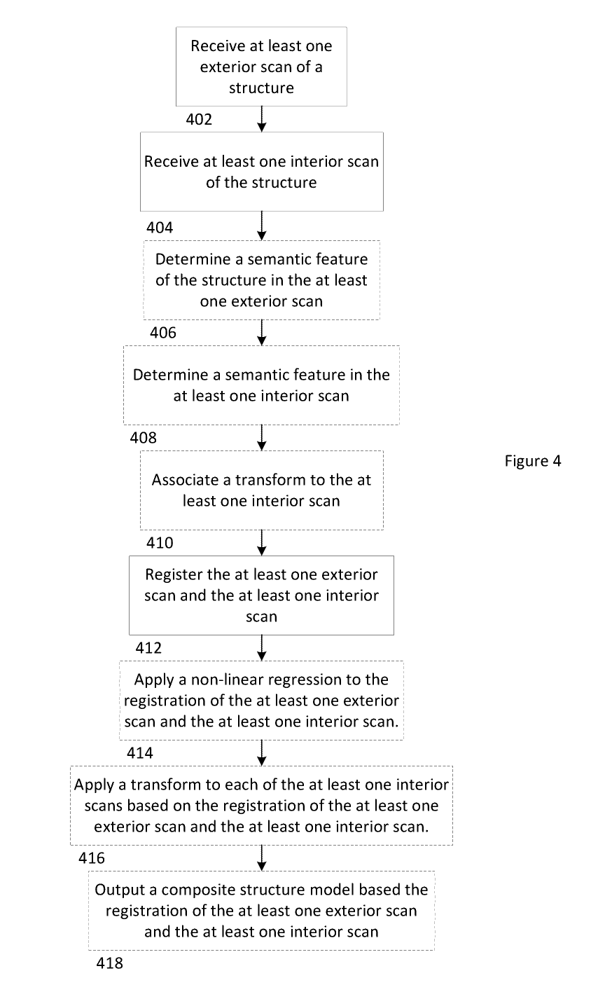

Referring now to FIG. 4, the operations performed, such as by the apparatus 200 of FIG. 2, for registration of interior and exterior three dimensional scans based on a semantic feature of a structure are illustrated. As shown in block 402 of FIG. 4, the apparatus 200 may include means, such as a processor 202, memory 204, a communications interface 206, or the like, configured to receive at least one external scan of a structure. The processor 202 may receive the external scans from the communications interface 206, which may in turn receive the external scans from a memory 204, such as a scan database 106, or from a scan capture device 108.

The scans may be a point cloud, or a data set in a three dimensional coordinate system, representing measurements of the exterior of a structure. The exterior scans may include one or more semantic features, such as windows, doors, or the like.

As shown in block 404 of FIG. 4, the apparatus 200 may include means, such as a processor 202, memory 204, a communications interface 206, or the like, configured to receive at least one interior scan of the structure. The processor 202 may receive the interior scans from the communications interface 206, which may in turn receive the interior scans from a memory 204, such as a scan database 106, or from a scan capture device 108.

The scans may be a point cloud, or a data set in a three dimensional coordinate system, representing measurements of the interior of a structure. The interior scans may include one or more semantic features, such as windows, doors, or the like.

As shown at block 406 of FIG. 4, the apparatus 200 may include means, such as a processor 202, or the like, configured to determine a semantic feature of the structure in the at least one exterior scan. The processor 202 may assume a gravity vector and detect vertical planes. For each of the detected vertical planes, the processor 202 may divide the vertical plane into a plurality of equal length bins and count the number of points in each bin.

Semantic features, such as windows, doors, or the like, may be recessed from the exterior walls. Therefore, a low point counter may indicate an opening. The processor 202 may group neighboring bins, which indicate an opening, into a semantic feature. In an instance in which the structure is multi story, a horizontal scan may also be performed for the exterior scans. The intersection of low-counting vertical and horizontal bins may indicate a semantic feature, such as a window.

As shown at block 408 of FIG. 4, the apparatus 200 may include means, such as a processor 202, or the like, configured to determine a sematic feature of the structure in the at least one interior scan. The processor 202 may assume a gravity vector and detect vertical planes, similar to the process described in block 306. For each of the detected vertical planes, the processor 202 may divide the vertical plane into a plurality of equal length bins and count the number of points in each bin.

Semantic features, such as windows, doors, or the like, may be recessed from the interior walls. Therefore, a low point counter may indicate an opening. The processor 202 may group neighboring bins, which indicate an opening, into a semantic feature.

In some example embodiments, such as in which sematic features of the interior scan may be obfuscated by furniture, curtains, or the like, the processor 202 may utilize a supervised machine learning to identify semantic features.

As shown at block 410 of FIG. 4, the apparatus 200 may include means, such as a processor 202, or the like, configured to associate a transform to the at least one interior scan. The processor 202 may associate each of the interior scans with a rigid transformation.

As shown at block 412 of FIG. 4, the apparatus 200 may include means, such as a processor 202, or the like, configured to register the at least one exterior scan and the at least one interior scan. The processor 202 may apply the maximization function which maximizes the overlap between the semantic features and minimizes the orientation difference of the plane to which the respective semantic feature corresponds. The maximization function may be the maximization function of Equation 1.

As shown at block 414 of FIG. 4, the apparatus 200 may include means, such as a processor 202, or the like, configured to apply a non-linear regression to the registration of the at least one exterior scan and at least one interior scan. The processor 202 may apply the non-linear regression, such as the LaGrange multiplier, to maximize the overlap and minimize the orientation differences of the semantic features. In an example embodiment, the processor 202 may determine an error associated with the registration of the exterior scan and the interior scan. The transform applied to the interior scan may be incremented and the registration reperformed, e.g. the maximization function of Equation 1 applied based on the incremented transform. The processor 202 may determine an error associated with the second registration. The processor 202 may repeat the transform incrementing and registration process, until the processor determines that the error satisfies a predetermined error threshold, such as zero or 10 mm, or the change in registration error satisfies a predetermined change threshold, such as zero or 0.1%.

As shown in block 416 of FIG. 4, the apparatus 200 may include means, such as a processor 202, or the like, configured to apply a transform to each of the at least one interior scans based on the registration of the at least one exterior scan and at least one interior scan. The processor 202 may apply transforms which may minimize the distance between the cloud points of the interior scans.

As shown in block 418 of FIG. 4, the apparatus 200 may include means, such as a processor 202, memory 204, user interface 208, or the like, configured to output a composite structure model. The processor 202 may generate the composite structure model based on the registered exterior and interior scans. The processor 202 may store the composite structure model in a memory 204, such as the scan database 106. The processor 202 may output the composite structure model to a user interface 208 for display.

The registration of external and interior scans of a structure based on a semantic feature allows for accurate alignment of the interior and exterior scans. The location data of the interior scans may be used for rough localization which is refined by the more precise locations of the exterior scan.

As described above, FIG. 4 illustrates a flowchart of an apparatus 200, method, and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 204 of an apparatus employing an embodiment of the present invention and executed by a processor 202 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as illustrated by the dashed outline of blocks 406-410 and 414-418 in FIG. 4. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving at least one exterior scan and at least one interior scan of a structure; and
registering the at least one exterior scan and the at least one interior scan based on a semantic feature of the structure, wherein the sematic feature of the structure is present in the at least one exterior scan and the at least one interior scan.

2. The method of claim 1 further comprising:
determining the semantic feature of the structure in the at least one exterior scan and the at least one interior scan.

3. The method of claim 1 further comprising:
associating a transform to the at least one interior scan; and
wherein the registering the at least one exterior scan to the at least one interior scan comprises applying the transform to the at least one interior scan.

4. The method of claim 1, wherein the registering the at least one exterior scan and the at least one interior scan comprises applying a maximization function.

5. The method of claim 4 further comprising;
applying a non-linear regression to the maximization function.

6. The method of claim 1 further comprising:
refining the transform associated with the respective interior scans of the at least one interior scan based on the registration of the at least one exterior scan and the at least one interior scan.

7. The method of claim 1 further comprising:
outputting a composite structure model.

8. An apparatus comprising at least one processor and at least one memory including computer program code, the at least one memory and computer program code configured to, with the processor, cause the apparatus to at least:
receive at least one exterior scan and at least one interior scan of a structure; and
register the at least one exterior scan and the at least one interior scan based on a semantic feature of the structure, wherein the sematic feature of the structure is present in the at least one exterior scan and the at least one interior scan.

9. The apparatus of claim 8, wherein the at least one memory and the computer program code are further configured to:
determine the semantic feature of the structure in the at least one exterior scan and the at least one interior scan.

10. The apparatus of claim 8, wherein the at least one memory and the computer program code are further configured to:
associate a transform to the at least one interior scan; and
wherein the registering the at least one exterior scan to the at least one interior scan comprises applying the transform to the at least one interior scan.

11. The apparatus of claim 8, wherein the registering the at least one exterior scan and the at least one interior scan comprises applying a maximization function.

12. The apparatus of claim 11, wherein the at least one memory and the computer program code are further configured to:
apply a non-linear regression to the maximization function.

13. The apparatus of claim 8, wherein the at least one memory and the computer program code are further configured to:
refine the transform associated with the respective interior scans of the at least one interior scan based on the registration of the at least one exterior scan and the at least one interior scan.

14. The apparatus of claim 8, wherein the at least one memory and the computer program code are further configured to:
output a composite structure model.

15. A computer program product comprising at least one non-transitory computer-readable storage medium having computer-executable program code portions stored therein, the computer-executable program code portions comprising program code instructions configured to:
receive at least one exterior scan and at least one interior scan of a structure; and
register the at least one exterior scan and the at least one interior scan based on a semantic feature of the structure, wherein the sematic feature of the structure is present in the at least one exterior scan and the at least one interior scan.

16. The computer program product of claim 15, wherein the computer-executable program code portions further comprise program code instructions configured to:
determine the semantic feature of the structure in the at least one exterior scan and the at least one interior scan.

17. The computer program product of claim 15, wherein the computer-executable program code portions further comprise program code instructions configured to:
associate a transform to the at least one interior scan; and
wherein the registering the at least one exterior scan to the at least one interior scan comprises applying the transform to the at least one interior scan.

18. The computer program product of claim 15, wherein the registering the at least one exterior scan and the at least one interior scan comprises applying a maximization function.

19. The computer program product of claim 18, wherein the computer-executable program code portions further comprise program code instructions configured to:
apply a non-linear regression to the maximization function.

20. The computer program product of claim 15, wherein the computer-executable program code portions further comprise program code instructions configured to:
refine the transform associated with the respective interior scans of the at least one interior scan based on the registration of the at least one exterior scan and the at least one interior scan.

21-28. (canceled)
